(19) United States
(12) Patent Application Publication
(10) Pub. No.: US 2022/0297363 A1
(43) Pub. Date: Sep. 22, 2022

(54) METHOD AND DEVICE FOR FORMING AN ARTICLE WITH A TEXTURED SURFACE BACKGROUND

(71) Applicant: Sharklet Technologies, Inc., Aurora, CO (US)

(72) Inventor: Ryan Eugene Stoneberg, Aurora, CO (US)

(21) Appl. No.: 17/619,330

(22) PCT Filed: Jun. 19, 2020
(86) PCT No.: PCT/US2020/038664

§ 371 Date: Dec. 15, 2021

Related U.S. Application Data
(60) Provisional application No. 62/863,349, filed on Jun. 19, 2019.

(51) Int. Cl. B29C 48/00; B29C 48/06; B29C 59/04

(52) U.S. Cl. CPC B29C 48/0011; B29C 48/06; B29C 48/002; B29C 59/04

(57) ABSTRACT

Disclosed herein is a method of forming a bioadhesion resistant article comprising extruding a material through a die bearing a pattern of protrusions such that the extruded material has a surface having a series of parallel splines above a base surface, and applying pressure with a first patterned template to the surface of the extruded material such that the series of parallel raised splines are formed into discrete raised segments of varying length; where the patterned template comprises grooves that are inclined at an angle α to the splines. The method further comprises applying pressure with a second patterned template to the surface of the extruded material, where the second patterned template contains grooves that are inclined at an angle β to the splines.

### CROSS REFERENCE TO RELATED APPLICATIONS

This application claims the benefit of U.S. Application No. 62/863,349 filed on Jun. 19, 2019, which is incorporated herein by reference in its entirety.

### STATEMENT REGARDING FEDERALLY SPONSORED RESEARCH OR SUPPORT

This invention was made with government support under 5R44HD085616-03 awarded by the U.S Department of Health and Human Services has certain rights in this invention.

### BACKGROUND

Disclosed herein is a method and a device for forming an article with a textured surface.

Textured surfaces can be used for a variety of functions such as controlling bioadhesion or flow. Since the texturing is on the order of micrometers or nanometers, mass producing such surfaces economically in large quantities is difficult. It is therefore desirable to have an efficient manufacturing process where these surfaces can be mass produced in large quantities.

### SUMMARY

Disclosed herein is a method of forming a bioadhesion resistant article comprising extruding a material through a die bearing a pattern of protrusions such that the extruded material has a surface having a series of parallel splines above a base surface, and applying pressure with a first patterned template to the surface of the extruded material such that the series of parallel raised splines are formed into discrete raised segments of varying length; where the patterned template comprises grooves that are inclined at an angle α to the splines. The method further comprises applying pressure with a second patterned template to the surface of the extruded material, where the second patterned template contains grooves that are inclined at an angle β to the splines.

### BRIEF DESCRIPTION OF THE FIGURES

FIG. 1 is an exemplary depiction of one embodiment of a patterned surface; and

FIG. 2 is a depiction of an exemplary embodiment of a device that may be used to texture a surface.

### DETAILED DESCRIPTION

Disclosed herein is a device and a method for manufacturing a textured surface. The device comprises a production device for producing an article with a first portion of the texture on the article surface and a modifying device for modifying the first portion of the texture to create a second portion of the texture. The modifying device lies downstream of the production device and modifies the first portion of the texture by crushing, etching, depressing or ablating a part of the first portion of the texture. The article can be a sheet or a tube.

Disclosed herein is a method of forming a bioadhesion resistant article comprising extruding a material through a die bearing a pattern of protrusions such that the extruded material has a surface having a series of parallel splines above a base surface, and applying pressure with a first patterned template to the surface of the extruded material such that the series of parallel raised splines are formed into discrete raised segments of varying length; where the patterned template comprises grooves that are inclined at an angle α to the splines.

The method further comprises applying pressure with a second patterned template to the surface of the extruded material, where the second patterned template contains grooves that are inclined at an angle β to the splines. In an embodiment, the angle α is equal to the angle β, while in another embodiment, the angle α is not equal to the angle β. In an embodiment, the angle α and the angle β are both greater than 40 degrees.

In an embodiment, the grooves of the first patterned template have a thickness “t” that is 10 nanometers to 100 micrometers, and wherein the distance “d” between the grooves of the first template is 10 nanometers to 100 micrometers. The grooves of the second patterned template have a thickness “t” that is 10 nanometers to 100 micrometers, and wherein the distance “d” between the grooves of the second template is 10 nanometers to 100 micrometers. In an embodiment, the first patterned template and the second patterned template are rollers, whose axis is parallel to the longitudinal axis of the extruded material. In an embodiment, the rollers can rotate around the extruded material (when the extruded material is in the form of a conduit), while contacting it during the entire rotation.

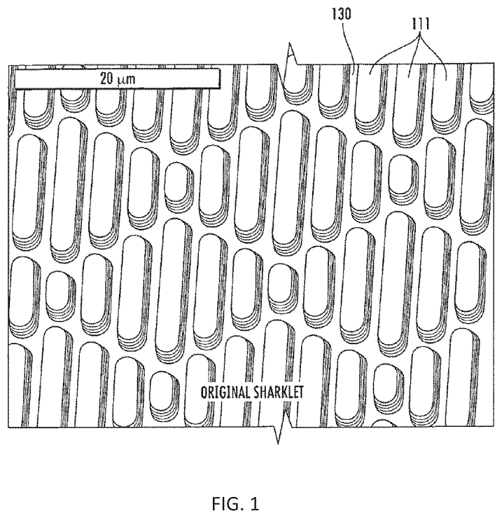

FIG. 1 depicts the texture that is disposed on the surface of the article. The article comprises a substrate upon which are disposed a plurality of features 111. The plurality of features project out from, or alternatively, project into a base surface 130. The base surface 130 is the surface of the substrate.

Base surface 130 can be a sheet of material which can be applied to other surfaces such as boats, ships bridges or the like, a roofing material, the inner surface of a water inlet pipe for a power or water treatment plant, an implantable medical device or material, such as a breast implant, a catheter or a heart valve or similar articles. Alternatively, the base surface can be the article surface and the features (that form the texture) can project out from, or alternatively, project into a base surface 130. These features will be discussed in detail later.

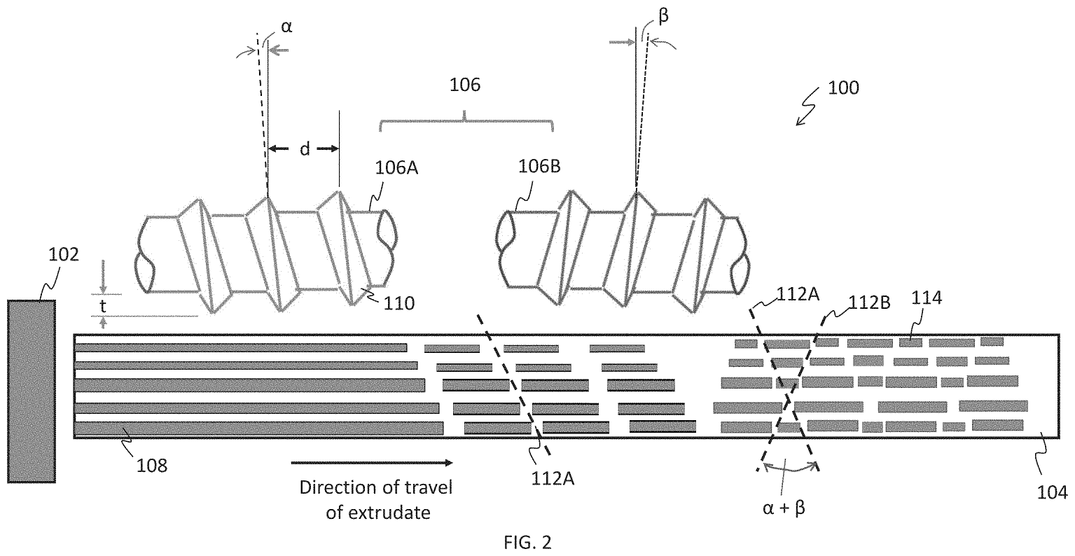

With reference now to FIG. 2, the device 100 comprises a production device 102 that produces an article 104 with the first portion of the texture 108. In an embodiment, the first portion of the texture comprises splines that extend along the entire length of the base surface of the article 104. The splines may project outward from the base surface or alternatively, project inwards from the base surface. The splines are 10 nanometers to 100 micrometers

The article 104 may be a tube, a cylinder or a sheet. As the article travels forward (as a result of more material emanating from the production device 102), it is contacted by one or more modifying devices 106A, 106B. In one embodiment, the modifying device is a grooved surface (comprising grooves 110) that is depressed into the surface of the article 104 upon contacting it. In one embodiment, the first modifying device 106A and the second modifying device 106B rotate about an axis that lies in the plane of the paper and that is also parallel to the direction of travel of the article 104. Both modifying devices can rotate in the same direction or in opposite directions so long as both devices are not in the same place at the same time. In an embodiment, the modifying device 106A and 106B can travel around the circumference of a circular article to produce paths 112A and 112B, which are discussed in detail below.

When the first modifying device 106A contacts the article surface it crushes the splines (i.e., modifies the first portion of the texture) to produce a first path 112A on the surface of the article. This first path is inclined at an angle α to a perpendicular to the direction of travel. When the splines are projected outwards from the base surface, the grooves of the modifying device do not penetrate into the base surface during the crushing of the splines. The angle α can vary from 5 degrees to 80 degrees. The grooves have a thickness “t” that is 10 nanometers to 100 micrometers, preferably 1 micrometer to 5 micrometers. The distance “d” between the grooves (also known as the pitch of the grooves) is 10 nanometers to 100 micrometers.

When the splines are projected into the base surface, the first modifying device 106A is depressed into the surface of the article to a depth that is equal to or less than the depth of the splines. The texture remaining on the article after it is contacted by the first modifying device comprises a series of projections having a length that is equal to pitch “d” of the grooves.

When the article is contacted by the second modification device 106B, it too crushes the splines producing a second path 112B. The second modifying device 106B also rotates about an axis that is parallel to the direction of travel of the article. When the second modifying device 106B contacts the article surface it too crushes the splines (i.e., modifies the first portion of the texture) to produce a second path 112B on the surface of the article. This second path is inclined at an angle β to a perpendicular to the direction of travel. The angle β can vary from 5 degrees to 80 degrees. The angles α and β are measured in opposite directions.

It is preferable for both angles α and β to each be greater than 40 degrees.

The grooves on the second modifying device also have a thickness “t” that is 10 nanometers to 100 micrometers, preferably 1 micrometer to 5 micrometers. The distance “d” between the grooves (also known as the pitch of the grooves) is 10 nanometers to 100 micrometers. As can be seen each roller (template) has a plurality of grooves. These grooves (on a single template) may be parallel to each other. In another embodiment, these grooves on a single roller may not be parallel to each other.

The angle between the paths 112A and 112B are dependent upon the values of α and β and are equal to the sum of α+β. The values of α and β may be the same or may be different from each other. In an embodiment, the value of α is greater than β or vice versa. In other words, it is desirable for the values of α and β to be different from each other. As may be seen in the FIG. 2, the paths 112A and 112B intersect periodically. The path 112A and 112B can be seen to combine to produce a sinusoidal pathway as seen in the FIG. 1.

The angle between the paths 106A and 106B are also dependent upon the linear velocities of the article 104 (along its direction of travel) and the linear velocities of the first and second modifying devices.

The texture produced by the modifying devices are detailed below.

In one embodiment, an article having a surface topography for resisting bioadhesion of organisms, comprises a base article having a surface. The composition of the surface and/or the base article comprises a polymer, a metal or an alloy, a ceramic. Combinations of polymers, metals and ceramics may also be used in the base article. The surface having a topography comprising a plurality of patterns; each pattern being defined by a plurality of spaced apart features projecting from the base article. The plurality of features each have at least one microscale (micrometer or nanometer sized) dimension and has at least one neighboring feature having a substantially different geometry. The average first feature spacing between the adjacent features is preferably at least 1 nm, more preferably at least 10 nm, more preferably still at least 100 nm, yet more preferably at least 1 micron, even more preferably at least 10 microns and no more than 500 microns, preferably no more than 200 microns, more preferably no more than 100 microns, on at least a portion of the surface, wherein said plurality of spaced apart features are represented by a periodic function. It is to be noted that each of the features of the plurality of features are separated from each other and do not contact one another.

The method is convenient for making an article where the surface is monolithically integrated with said base article, wherein a composition of the base article is the same as the composition of the surface. In another embodiment, the method is useful in making a patterned sheet which is subsequently adhered to the base article. The composition of the adhered sheet may be different from the composition of the base article.

As noted above, the pattern is separated from a neighboring pattern by a tortuous pathway. The tortuous pathway may be represented by a periodic function. The periodic functions may be different for each tortuous pathway. In one embodiment, the patterns can be separated from one another by tortuous pathways that can be represented by two or more periodic functions. The periodic functions may comprise a sinusoidal wave. In an exemplary embodiment, the periodic function may comprise two or more sinusoidal waves.

In one embodiment, the plurality of spaced apart features have a substantially planar top surface. In another embodiment, a multi-element plateau layer can be disposed on a portion of the surface, wherein a spacing distance between elements of said plateau layer provide a second feature spacing; the second feature spacing being substantially different when compared to the first feature spacing. The secondary patterning can be achieved by patterning on the die and/or by patterning on the press.

The method of this invention is especially useful in making articles where the spaced features similar geometries and different dimensions as shown in FIG. 1. While various articles with features of various geometries can be made by this method depending upon the projections in the die and the pattern on the surface of the press, the invention is particularly suitable for making polygons, especially quadrilaterals, triangles, and the like.

As will be noted below, the tortuous pathway may be defined by a sinusoidal function, a spline function, a polynomial function, or the like. The tortuous pathway generally exists between a plurality of groupings of spaced features and may occasionally be interrupted by the existence of a feature or by contact between two features. The tortuous pathway can have a length that extends over the entire length of the surface upon which the pattern is disposed, if the features that act as obstructions in the tortuous pathway are by-passed. The width of the tortuous pathway as measured between two adjacent features of two adjacent patterns are about 10 nanometers to about 500 micrometers, specifically about 20 nanometers to about 300 micrometers, specifically about 50 nanometers to about 100 micrometers, and more specifically about 100 nanometers to about 10 micrometers.

In one embodiment, the spaced features have linear pathways or channels between them.

As noted above, the spaced features can have different dimensions (sizes of height, width and length). The average size of the spaced features can be nanoscale (e.g., they can be less than 100 nanometers) or greater than or equal to about 100 nanometers. In one embodiment, the spaced features can have average dimensions independently in each direction of height, width, and length of at least 1 nanometer, specifically at least 10 nanometers, more specifically at least 100 nanometers, yet more specifically at least 500 nanometers, and most specifically at least 1 micron and not more than 500 micrometers, specifically not more than about 200 microns, more specifically no more than about 100 microns, yet more specifically no more than about 50 microns, and most specifically no more than about 10 microns. Generally, the features will have similar heights and adjacent features will have at least one of length or width that are different from the adjacent feature

In another embodiment, the average periodicity between the spaced features can be about 1 nanometer to about 500 micrometers. In one embodiment, the periodicity between the spaced features can be about 2, 5, 10, 20, 50, 100 or 200 nanometers. In another embodiment, the average periodicity between the spaced features can be about 2, 5, 10, 20, 50, 100 or 200 nanometers. In another embodiment, the periodicity can be about 0.1, 0.2, 0.5, 1, 5, 10, 20, 50, 100, 200, 300, 400 or 450 micrometers. In yet another embodiment, the average periodicity can be about 0.1, 0.2, 0.5, 1, 5, 10, 20, 50, 100, 200, 300, 400 or 450 micrometers.

In one embodiment, each feature of a pattern has at least one neighboring feature that has a different geometry (e.g., size or shape). A feature of a pattern is a single element. Each feature of a pattern has at least 2, 3, 4, 5, or 6 neighboring features that have a different geometry from the feature.

The materials used in making the article in the present method must be suitable for extruding through a die and for molding with a press. Examples of such materials are metals, polymers, and in some cases ceramics. Polymeric materials are particularly suitable. Thermoplastics are preferred according to one embodiment. Cross-linkable thermoplastics are also preferred if the article will be subject to high temperatures during its use to prevent reflow and loss of the pattern of features. Certain thermosetting materials may be used provided they can be extruded at a temperature below the temperature at which thermosetting occurs. Then final cure can occur during or after the pressing of the mold on the structure. Blends of polymers and copolymers may be used. Polymers having a low surface tension or other desirable surface characteristics may also be used.

Examples of the organic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene propylene diene rubber (EPR), polytetrafluoroethylene, perfluoroelastomers, fluorinated ethylene propylene, perfluoroalkoxyethylene, polychlorotrifluoroethylene, polyvinylidene fluoride, polysiloxanes, or the like, or a combination comprising at least one of the foregoing organic polymers.

The method disclosed herein is advantageous in that it can result in the rapid production of uniform and consistent texture across the surface of a moving product.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A method of forming a bioadhesion resistant article comprising:
extruding a material through a die bearing a pattern of protrusions such that the extruded material has a surface having a series of parallel splines above a base surface,
applying pressure with a first patterned template to the surface of the extruded material such that the series of parallel raised splines are formed into discrete raised segments of varying length; where the patterned template comprises grooves that are inclined at an angle α to the splines.

2. The method of claim 1, further comprising applying pressure with a second patterned template to the surface of the extruded material, where the second patterned template contains grooves that are inclined at an angle β to the splines.

3. The method of claim 2, wherein the angle α is equal to the angle β.

4. The method of claim 2, wherein the angle α is not equal to the angle β.

5. The method of claim 2, wherein the grooves of the first template have a thickness “t” that is 10 nanometers to 100 micrometers, and wherein the distance “d” between the grooves of the first template is 10 nanometers to 100 micrometers.

6. The method of claim 2, wherein the grooves of the second template have a thickness “t” that is 10 nanometers to 100 micrometers, and wherein the distance “d” between the grooves of the second template is 10 nanometers to 100 micrometers.

7. The method of claim 2, wherein the first patterned template and the second patterned template are rollers, whose axis is parallel to the longitudinal axis of the extruded material.

8. The method of claim 2, wherein the angle α and the angle β are both greater than 40 degrees.

9. The method of claim 7, wherein each of the rollers can rotate around the extruded material.
